(19) United States
(12) Patent Application Publication
(10) Pub. No.: US 2009/0150452 A1
(43) Pub. Date: Jun. 11, 2009

(54) ACTIVITY-RELATED DOCUMENT MANAGMENET

(75) Inventor: Markus Gerardus Leonardus Maria Van Doorn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,768

(22) PCT Filed: Nov. 30, 2005
(86) PCT No.: PCT/IB05/53979

§ 371 Date: May 21, 2007

Related U.S. Application Data
(60) Provisional application No. 60/632,138, filed on Dec. 1, 2004.

(51) Int. Cl. G06F 17/30

(52) U.S. Cl. 707/201; 707/E17.005

(57) ABSTRACT

An activity sharing management system (1-1) in an ambient intelligence environment is provided. The system includes a document manager (1-11) configured to manage a first and a second set of documents that contain setting information for an ambient intelligence activity of the first and second user, respectively, and an overlap manager (1-13) that determines a degree of influence and/or overlap based, for example, on common variables. Also disclosed is a method of managing behavior-specified links in a multiple active document environment active in a browser (2-1), including, providing for a set of documents, each document specifying setting information for a user activity, to be active simultaneously; receiving (S4) a behavior-specified link command (2-20) included in a first document (2-11) of the set of documents, the command affecting at least a second document (2-12) of the set of documents; and executing (S6) the command over the active document set.

The present invention relates to the field of activity-related document management, ambient intelligence environment systems, multiple active document handling systems, and In recent years, more and more devices have become “wired,” making it possible to manage the functioning of these devices in an organized way. Also, ambient intelligence systems have emerged which provide a digital environment that is sensitive, adaptive, and responses to the presence of the people in the environment. In an ambient intelligence system, electronic devices are embedded in the furniture, clothing or other parts of the environment, and based on the user's activities detected by sensors of the system, devices are activated and services and information are delivered for the user.

In ambient intelligence environments, more than one person often shares the environment, which causes activities of one user to affect the environment and thereby impact the second user sharing the environment. Approaches exist for modeling and sharing activities, however these approaches are mostly concerned with sharing a piece of content with others or with joining or splitting activities using a graphical user interface (GUI). However, since a person's activities in an ambient intelligent environment may, to some extent, influence or affect the activities of the second (and third, fourth, et cetera) person sharing the environment, these approaches often fail in determining a degree of influence or a degree of overlap between the activities of the users.

Further, a user may be simultaneously using several wired devices, such that it would be desirable for the user's actions or activities with respect to one device or with respect to one activity to affect a second device or second activity. For example, in an ambient intelligence browser, the user may wish to control the operation or state of the device using a second device with which the user is engaged. Such a browser may have an active document with a link, the document corresponding to a first user activity, and additional active documents corresponding to other activities of the user. Each activity of a user is represented by a document and the ambient intelligence browser can at any time support 0 to N activities (and corresponding documents) as active.

Each document describes how the presentation is rendered on one or more devices, that is where multimedia elements are to be presented in space (on which device and on which part of the screen, for example) and in time (some multimedia objects begin to play when others have stopped). An example of a document language that supports this is the SMIL language defined by the W3C (http://www.w3.org/AudioVideo/). The document also describes how users can interact with the application by means of forms that describe user interface widgets such as submit buttons, dropdown lists, text fields or the like. An example of a document language that supports this is XForms (http://www.w3.org/MarkUp/Forms/). XForms is intended to be used in conjunction with a web presentation language such as HTML or SMIL. Besides this functionality, the document has linking functionality.

XLink (http://www.w3.org/XML/Linking) is a language for describing links and, like XForms, is meant to be used in conjunction with a presentation language like HTML or SMIL. XLink (http://www.w3.org/XML/Linking) defines a “show” attribute that is also used to communicate the desired presentation of the ending resource (end point of the link; the music playing document) on traversal from the starting resource (the begin point of the link; the webcam document). However, in XLink, and in presentation languages like HTML and SMIL for which XLink was meant, only one document at any given time is active. Only one document has focus.

Provided are a method, system, device, apparatus, and computer-readable media that embodies or carries out the functions of activity-related document management and behavior-related link management.

An activity sharing management system is provided, the system including a document manager configured to manage or generate a first and second set of documents, such that each document of the first set of documents contains setting information for an ambient intelligence activity of a first user and for the second set of documents, each document contains setting information for a corresponding ambient intelligence activity of a second user. In addition, an overlap manager of the system may determine a degree of influence in an ambient intelligence environment between the first user and the second user based, for example, on an overlap of the first set of documents and the second set of documents.

Such a degree of influence may be a degree of overlap between the activity of the first user and the corresponding activity of the second user. The overlap manager may determine the degree of influence by comparing public variables used by the first set of documents and the second set of documents.

A browser may also be connected, which manages the first and second sets of documents. Such a browser may be an ambient narrative browser, and the first and second sets of documents may contain user ambient intelligence activity settings.

Also disclosed is a method of managing behavior-specified links in a multiple active document environment. The method may include providing for a set of documents to be active simultaneously, each document of the set of documents specifying setting information for a user activity; receiving a behavior-specified link command included in a first document of the set of documents, the command affecting at least a second document of the set of documents; and executing the command.

The behavior-specified link command may retrieve information for the second document, replace the second document with a target document that is linked to in the behavior-specified link command, or may remove the second document from the active set.

The behavior-specified link command may change an operation a device associated with the second document or change a state of the device associated with the second document.

The behavior-specified links may be managed by a browser. Such a browser may be an ambient narrative browser and documents of the set of documents contain user ambient intelligence activity settings.

The behavior-specified link command of the first document may be triggered by an event related to the user activity specified by the first document.

The behavior-specified link command could also include a link to a plurality of documents, and could specify that the plurality of documents affect a second document and a third document of the set of documents. Additional document sets of additional users may also be handled.

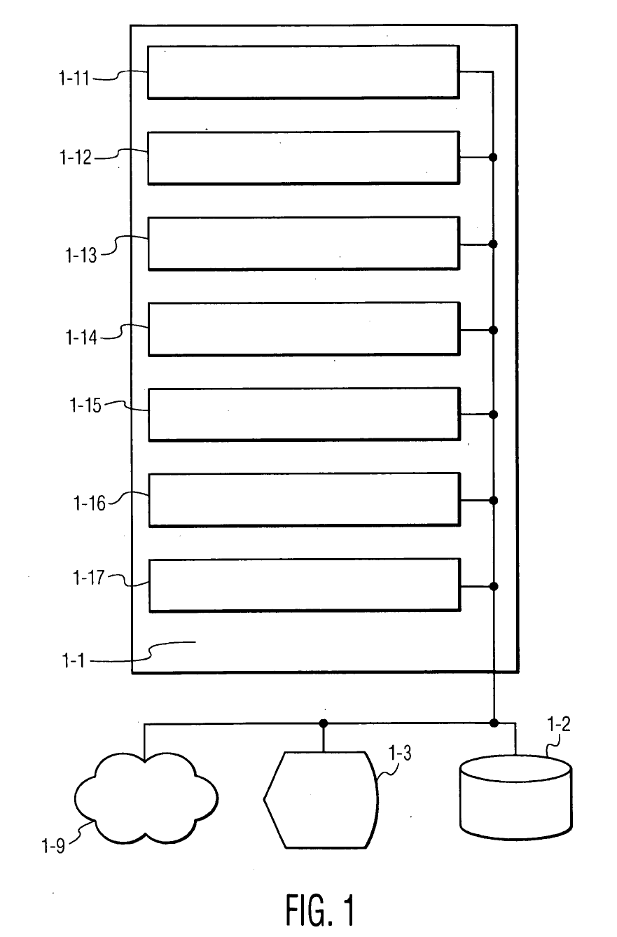

FIG. 1 is a schematic view of an activity-related document management system according to an embodiment of the present invention.

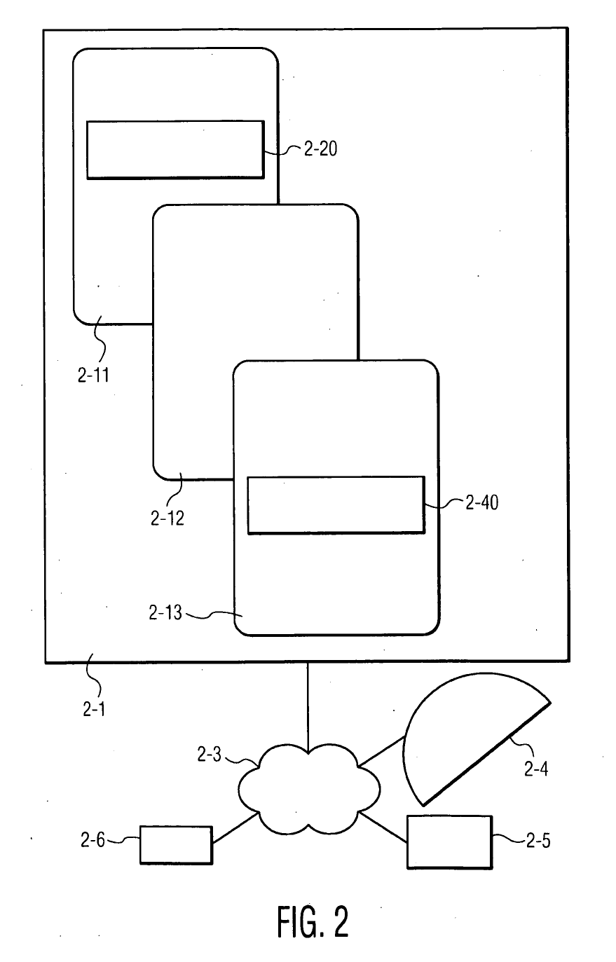

FIG. 2 is a browser according to an aspect of the present invention connected to a network, with external devices and a server connected to the network.

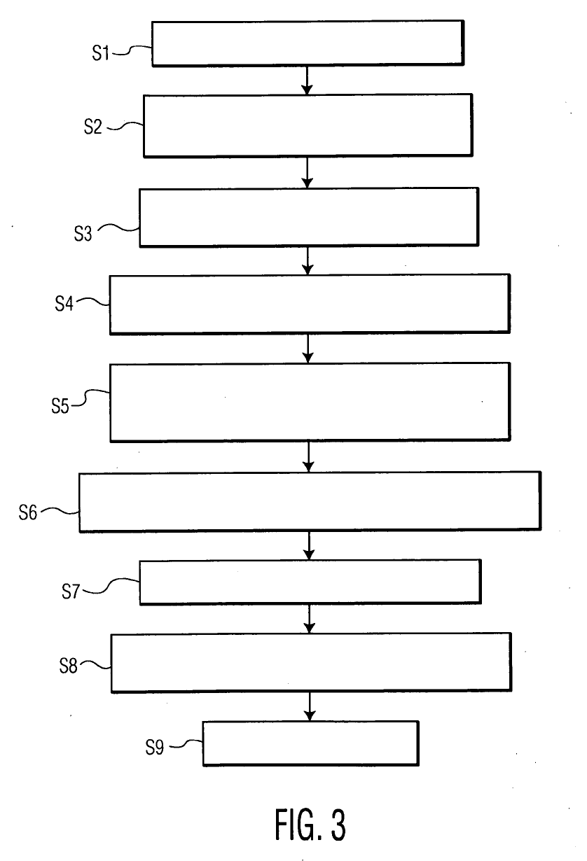

FIG. 3 is a flowchart for an operation of an activity-related document manager according to an aspect of the present invention.

The following discussion and the foregoing figures describe embodiments of Applicant's invention as best understood presently by the inventors however, it will be appreciated that numerous modifications of the invention are possible and that the invention may be embodied in other forms and practiced in other ways without departing from the spirit of the invention. Further, features of embodiments described may be omitted, combined selectively or as a whole with other embodiments, or used to replace features of other embodiments, or parts thereof, without departing from the spirit of the invention. The figures and the detailed description are therefore to be considered as an illustrative explanation of aspects of the invention, but should not be construed to limit the scope of the invention.

As shown in FIG. 1, the activity-related document management system 1-1 includes several modules, which will be described below. Modules of the activity-related document management system 1-1, or portions thereof, and/or the activity-related document management system as a whole, may be comprised of hardware, software, firmware, or a combination of the foregoing, however some modules may be comprised of hardware for example, while other modules may be comprised of software, firmware or a combination thereof.

It is to be understood that modules of the activity-related document management system need not all be located or integrated with the same device. A distributed architecture is also contemplated for the activity-related document management system, which may “piggy-back” off of suitable modules provided by existing devices.

The following description will refer to an activity-related document management system 1-1 that is physically integrated with or connected to a database 1-2 via a wired or wireless connection thereto. The database 1-2 may be embodied on a storage device such as on a hard drive of a personal computer, a personal video recorder, an entertainment system, an electronic organizer, a personal handheld device, a Jaz drive, or may be embodied as a commercial storage facility, such as a disk drive. For example, a commercial storage facility may include a storage space provided by a service provider, or residing in the network. It will be understood that the database 1-2 may include several storage devices that are connected, such that organization or grouping of content items on two or more of such devices is possible. For example, the data may be distributed over devices in a peer-to-peer network. By way of example, data derived from sensors may thus be handled. It will further be understood that the database may be understood to include one or more storage media, such as disks, including CDs, DVDs, zip disks, floppy disks, data cartridges, or the like, which can be loaded onto and retrieved by the database 1-2. However, it will be understood that the activity-related document management system 1-1 is also capable of retrieving content via a network 1-9, such as a LAN, WAN, the internet, or the like, and that the database may be remotely connected, such as via a network, including the internet.

As shown in FIG. 1, activity-related document management system 1-1 has a document manager which manages documents currently active in the system. For example, activity-related document management system 1-1 may comprise a browser or be logically connected to a browser, including an intelligent ambience browser. The document manager would also store for each active document data identifying to which user the active document belongs, which information could be used for comparing overlap, discussed below. The ambient intelligence browser may also be understood as comprising a module of network node outside of the activity-related document management system, for example as a kind of navigation browsing assistant. Alternatively, the document manager may be understood as the ambient intelligence browser plus the extra functionality of keeping track which users belong to which documents. As shown in FIG. 2, the browser according to an aspect of the present invention may provide for several active documents, shown as document 1, 2-11, document to, 2-12, and document three, 2-13. Such documents may control devices associated with activities performed by the user. There may be active several sets of such documents, each set corresponding, for example, to a different user. For instance, document 1, 2-11, is shown as the webcam application, which includes a behavior-specified link 1, 2-20. Thus, document 1 may contain settings information associated with one or more external devices, 2-4, 2-5, such as a webcam, and speakers. Document 2, 2-12, is given in the example of FIG. 2 as an audio playlist application, and document 3, 2-13 is shown as a slideshow application including a behavior-specified link M, 2-40.

The browser 2-1 may be connected to a network 2-3, such as the Internet, and the external devices 2-4 and 2-5 may be connected to network 2-3. The browser is shown in FIG. 1 as integrated with a user interface/browser 1-3. It will be understood however that the network 2-3 may be a local area network (LAN), a wide area network, a network to home or some other type of network. Also, external device 2-4 and external device 2-5 may be connected in a wired or wireless mode directly to the browser 2-1 or to a device physically integrated with the browser, such an ambient intelligence engine or system. The browser and devices would be able to communicate with each other, and a firewall that blocks data would typically not be deployed.

According to an aspect of the present invention, in an ambient intelligence environment, a document or a set of several documents may be created or destroyed by the system responsive to the activities of the user. For instance, when a user walks into a living room, based on sensor information detecting the presence and/or activities of the user, various devices may be activated for providing services or information to or for the user. Each activity may spawn one or several documents corresponding to a device 2-4, 2-5 or devices. As stated, such devices may be stand-alone devices 2-4, 2-5 or device embedded in the environment. For example, much of the interaction in an ambient intelligence environment is implicitly derived from sensor data. A common example of such a sensor is the one used near a door that automatically slides open when somebody stands in front of the door.

According to an aspect of the present invention, the browser manages both sets of documents (one set of documents for each user) at the same time. This is because two applications from different sets may render images on the same device, for example. Accordingly, the timing and synchronization of media elements is controlled centrally because otherwise the total presentation could run out of synchronization because different devices use different clocks. Controller 1-17 performs other functions of the activity-related management system 1-1, such as overall coordination of the modules and interfacing with a user (not shown) via user interface/browser 1-3.

An operation of the activity-related document management system 1-1 will now be described with reference to FIGS. 1-3. A user's activity, such as the operation of a webcam is detected at S1 of FIG. 3, and processing commences. An external device, such as the webcam, a screen, or speakers are shown as 2-4 and 2-5 of FIG. 2. It will be understood that many types of external devices or sensors may be suitably be used with such a system, including a personal video recorder, an entertainment system, an electronic organizer, a personal handheld device, a lamp, household appliances and fixtures, kitchen appliances and the like.

Document 1, shown as 2-11 of FIG. 2 contains settings for a Webcam activity of the user. Document manager 1-11 of FIG. 1 manages documents, such as document 1, 2-11, that are currently active, each document being associated with user activities. Preconditions are assigned to each document, which describe the context or situation (for example, the location, user, activity, devices and session variables). Document 1, 2-11, contains settings that control devices 2-4, 2-5, and responsive to user actions and events in the user's surroundings, the flow of control in the document will cause an instruction to be detected by the document settings detector 1-12 of the activity-related document management system 1-1. Appropriate action will be taken based on the instructions or settings in the document. For example, other devices, such as external devices 2-4 and/or 2-5, may be queried for information, or commanded to take certain actions via a command transmitted by the activity-related document management system 1-12. Thus, the document management system may typically instruct the browser about what to do (for example, show web cam application on a device that is suitable in the close proximity of the user), and the browser 2-1 would typically handle how this is done.

The documents can also contain links to other active documents or to documents external to the activity-related document management system 1-1. An instruction, such as a request for document or behavior-specified link would be triggered when processing reaches that portion of the document based on actions of the user or based on events in the ambient intelligence environment. When, at S2, browser 2-1 detects this instruction in document 1, it notifies, at S3, document settings detector 1-12. Link handler 1-14 of the activity-related document management system 1-1 interprets, at S4, the link command and accordingly updates, at S5, the active document set (comprising documents 1-3, shown as 2-11, 2-11 and 2-13, respectively). At S6, the document management system 1-1 sends the changes in the active document set to the browser 2-1. The browser 2-1, at S7, receives the update instruction(s), and at S8, starts and/or stops presentations as appropriate, based on the update instruction(s).

According to an implementation of the present invention, the browser 2-1 could actually send the link ID with the document ID to the document management system. The document management system then looks up the information that belongs to this link ID and document ID in the active document set. Accordingly, there may be no direct connection or communication from one document to another: the browser 2-1 notifies the document management system 1-1, which then sends back a new document to the browser 2-1 that is to be added or to replaces a document of the document set.

Server interface 1-16 of the activity-related document management system may also transmit a request to a Web server 2-6 via network 2-3 or to some other server or device to request information or to fetch the document based on the link. The activity-related management system 1-1 then receives the document requested, and document manager 1-11 returns requested information or the document as a whole to the requesting active document 1, 2-11, and/or provides information from the retrieved document to active document 2, thereby affecting operations of an external device associated with document 2.

According to an aspect of the present invention, to allow two applications/documents to share data, a “blackboard” approach may be used: Next to links in documents, session variable change elements are listed. When the browser has reached a session variable change element, the element ID and document ID are forwarded to the document management system which updates the session memory. All running applications can read from this session memory to change their state if needed without consulting the document manager. Changing this session memory may be done through the document manager 1-11 (to avoid concurrent write access to the same variable).

For example, FIG. 2 shows Document 1, 2-11, containing a behavior-specified link 1, 2-20. An example of such a document is set forth below:

## WEBCAM MULTIMEDIA APPLICATION

<smil>

<head>

<layout>
layout information: regions on the screen where

multimedia objects can be placed...

</layout>
</head>
<body>

description of the multimedia presentation/application...

<link id=”link1” behaviour=”add” from=”.”

to=http://anengine:8080/query?type=music_playing/>

more description...

</body>
</smil>

It will be understood that the instruction:

<link id=”link1” behaviour=”add” from=”.”
to=http://anengine:8080/query?type=music_playing/>

is an illustrative example of a format for a type of behavior-specified link, which specifies that the reference to the document specified by its URL is to be added to the set of active documents. In the example set forth in the above-enumerated code, the behavior-specified link includes an “add” command, which means that the retrieved document is added to the set of active documents currently running on the activity-related document management system, or more particularly, may mean that the retrieved document is to be added to that user's set of active documents, if there are several sets of active documents. Document manager 1-11 of the activity-related document management system may further notify Document 1 (the requesting document containing the behavior-specified link 1, 2-20). Processing is terminated at S9.

Another example of the behavior-specified link command in such an activity-related document management system 1-1 is a “replace” command:

## WEBCAM MULTIMEDIA APPLICATION
WITH REPLACEMENT ON DOCSET

<smil>

<head>

<layout>

layout information: regions on the screen where

multimedia objects can be placed...

</layout>

</head>

<body>
description of the multimedia presentation/application...

<link id=”link1” behavior=”replace”

from=http://anbrowser:8080/query?type=webcam
to=http://anengine:8080/query?type=music_playing />

more description...
</body>
</smil>

The “from” attribute in the link in the above-example of code is interpreted to mean that all applications of “type=webcam” are replaced with the document or documents that are returned by the query specified in the “to” attribute of the behavior-specified link. Thus, a behavior-specified link can affect one or more other active documents (multiple anchor documents) and can return the one or more requested documents (multiple target documents), or portions of one or more requested documents or information based on one or more active documents. It will be understood that the particular specifiers used as commands and the syntax of instructions are provided to illustrate aspects of the invention, and the invention may be embodied or practiced using other specifiers and instruction syntax.

Other attributes contained in Document 1 may include attributes that specify removing an active document, including removing Document 1 itself, or replacing document 1 itself; an attribute that specifies a query for information or request for external device status information from other active documents, or from external documents, a start instruction instructing start up of another active document or a device associated with the other active document, and a pause instruction, instructing halting of another active document or device associated with the other active document. Each of these specifiers or attributes may specify multiple target documents.

According to an aspect of the present invention, it is also possible to detect a degree of overlap between a first activity, Activity A, and a second activity, Activity B, which may be performed by one or more users. Activity/event detector 1-15 detects an activity A of a user. It should be understood that an event occurring in the environment, or a device status or operating in connection with that document active in the activity-related document management system 1-1 may also trigger such a detection. Based on the settings of active documents running on the activity-related document management system 1-1, overlap manager 1-13 detects a degree of overlap or degree of influence between activity A and activity B. This overlap can be calculated if for each document the participating users are known. As discussed, this associated user information is maintained by the document management system. The overlap manager 1-13 may further be implemented as integrated with or connected to the module of the document management system 1-1 that updates the active set of documents, such as, according to an illustrative embodiment, document manager 1-11.

For example, in an ambient intelligence environment, some documents associated with activities are denoted as “private” while others are denoted as “public.” Public documents are automatically shared with other users when they join the activity. All information about public documents is transmitted to the other users who share in his documents. Private documents on the other hand are not shared, but they still may affect other activities because they affect the environment. For instance, other users may hear the music related to an activity of a person engaged in an activity associated with a private document, if the other users are in the same room. Thus, private documents, while not shared, may still constrain or affect the possible choices for others' activities by altering system-wide variables.

When a public document is active, part of the interactive media around the user responds directly to the choices made by someone else, and the user can make changes that affect others, thus the users share in the activity with someone else. In such a public document example, the degree of activity overlap can be calculated. A degree of influence, a weaker measure then activity overlap, between two or more users might still exist if the intersection of private documents is non-empty.

That is, if the intersection of public documents is empty, then the users share no activity and the degree of overlap is zero. However in such a case, there still may be a degree of influence based on the intersection of the users' sets of private documents. If the intersection is only of private documents, the document sets will mutually influence each other if the documents sets have variables in common and take place in the same ambient intelligence environment or rendering space.

According to an aspect of the present invention, variables, including common variable, are assigned with a public attribute or a private attribute. Thus, for example, in a private document with one or more public variables, the public variables might influence the selection of other documents because they might be visible outside of the document. For instance, a “ConcentratedWorkingSession” activity document could have a public attribute “noAudio” that can be activated during the running presentation. Accordingly, another user is prevented from activating a link that brings up a loud music playlist while the other user is concentrating on some other activity. An example of a private variable might be a URL to a user profile, for example, that should be restricted to the user (for example, the user's personal data). The degree of influence between private documents can then be calculated by comparing the public variables of each document.

Embodiments of the present invention provided in the foregoing written description are intended merely as illustrative examples. It will be understood however, that the scope of the invention is provided in the claims.

1. An activity sharing management system comprising:
a document manager (1-11) configured to manage a first set of documents, each document of the first set of documents containing setting information for an ambient intelligence activity of a first user;
said document manager (1-11) further configured to manage a second set of documents, each document of the second set of documents containing setting information for a corresponding ambient intelligence activity of a second user;
an overlap manager (1-13) configured to determine a degree of influence in an ambient intelligence environment between the first user and the second user based on an overlap of the first set of documents and the second set of documents.

2. The system of claim 1, wherein the degree of influence is a degree of overlap between the activity of the first user and the corresponding activity of the second user.

3. The system of claim 1, comprising a browser (2-1) configured to manage the first and second sets of documents.

4. The system of claim 1, wherein the browser (2-1) is an ambient narrative browser and first and second sets of documents contain user ambient intelligence activity settings.

5. The system of claim 1, wherein the overlap manager (1-13) is configured to determine the degree of influence by comparing public variables used by the first set of documents and the second set of documents.

6. A method of managing behavior-specified links in a multiple active document environment, the method comprising:
providing (S1) for a set of documents to be active simultaneously, each document of the set of documents specifying setting information for a user activity;
receiving (S2) a behavior-specified link command (2-20) included in a first document (2-11) of the set of documents, the command affecting at least a second document (2-12) of the set of documents; and
transmitting a signal for executing (S6) the command.

7. The method of claim 6, wherein the behavior-specified link command at least one of retrieves information for the second document, replaces the second document with a target document linked to in the behavior-specified link command, and removes the second document.

8. The method of claim 6, wherein the behavior-specified link command at least one of changes an operation a device associated with the second document and a changes a state of the device associated with the second document.

9. The method of claim 8, wherein the behavior-specified links are managed by a browser (2-1).

10. The method of claim 9, wherein the browser is an ambient narrative browser and documents of the set of documents contain user ambient intelligence activity settings.

11. The method of claim 6, wherein the behavior-specified link command of the first document is triggered by an event related to the user activity specified by the first document.

12. The method of claim 6, wherein the behavior-specified link command links to a plurality of documents.

13. The method of claim 12, wherein the behavior-specified link command specifies that the plurality of documents affect a second document and a third document of the set of documents.
